(19) United States
(12) Patent Application Publication
(10) Pub. No.: US 2007/0039356 A1
(43) Pub. Date: Feb. 22, 2007

(54) Device on a rotary screen that is traversed from the exterior to the interior

(76) Inventor: Markus Leffler, Egelsbach (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/578,296

(22) PCT Filed: Nov. 8, 2004
(86) PCT No.: PCT/EP04/52842

§ 371 Date: May 4, 2006

(30) Foreign Application Priority Data
Nov. 12, 2003 (DE) 103 53 115.7

(51) Int. Cl. B08B 3/12

(52) U.S. Cl. 68/5 D

(57) ABSTRACT

The connecting element according to EP-A-0 315 961 has a flow-impeding cross section. This connecting element may also become soiled in the corners along the outside contour. This risk of soiling is eliminated due to the cross section of the novel connecting element. It is realized in a streamlined fashion and therefore shaped like an arrow at least in the direction of the inflowing fluid. The novel connecting element is realized with a cross-section that resembles that of a shuttle.

The invention pertains to a device for the flow-through treatment of textile materials, formed fabrics or paper by means of a gaseous or liquid treatment medium being circulated in the device, with a perforated cylinder that is provided with bottoms on the faces and the interior of which is subjected to suction, wherein said cylinder serves as a transport element and its periphery is covered with a wire gauze, wherein unbend sheet metal strips are arranged between the bottoms of the cylinder such that they extend in a straight fashion from one bottom to the other bottom and their width extends in the radial direction, wherein connecting elements are arranged between the sheet metal strips and uniformly distributed over the length of the cylinder, wherein said connecting elements have a width that corresponds to the nominal distance between two directly adjacent sheet metal strips and are rigidly connected to the adjacent sheet metal strips, and wherein the respective connecting element is realized in a web-shaped fashion, provided with at least one bore in the peripheral direction of the cylinder in order to accommodate at least one screw and/or a similar threaded fastening element, and can be connected to the two adjacent sheet metal strips or connecting elements.

A device of this type is known from EP-A-0 315 961. It has the unsurpassed advantage of a very high air permeability that is achieved without reducing the stability of the cylinder. The peripherally extending connecting elements are rigidly connected all around the cylinder to the sheet metal strips extending over the length of the cylinder by means of the proposed screw connection such that a welded construction is not required. This makes it possible to eliminate the disadvantageous structural changes in the metal that occur when the otherwise required welding seams are produced.

The connecting elements according to EP-A-0 315 961 only have a wall thickness that is sufficient for their stability. This is the reason why they are realized in a web-shaped fashion and thicker in the region of the screws than in the central region in order to accommodate the screws. It was determined in practical applications that soiling occurred at the transitions from the walls to the central region at the height of the screws, as well as at other locations. Lint accumulated on the connecting elements and impaired the flow-through effect.

The invention is based on the objective of developing a construction, in which not only soiling of the connecting elements is eliminated, but the flow-through effect is even advantageously improved.

Based on the device according to EP-A-0 315 961, this objective is attained in that the connecting element is realized in a flow-promoting fashion over at least part of its radial length. This can be realized by designing the radially outer region of the connecting elements in the shape of an arrow, wherein the connecting element then extends with this width up to the radially inner screws and is then once again advantageously pointed in an arrow-shaped fashion. Between the screws, the width of the body is only of insignificant stability-related importance such that the body can be realized in a hollow fashion at this location for weight reasons.

A device according to the invention is illustrated in an exemplary fashion in the figures. The figures show:

FIG. 1, a section along a conventional perforated cylinder device, the sleeve of which consists of a strip-shaped sheet metal structure with an outer wire gauze;

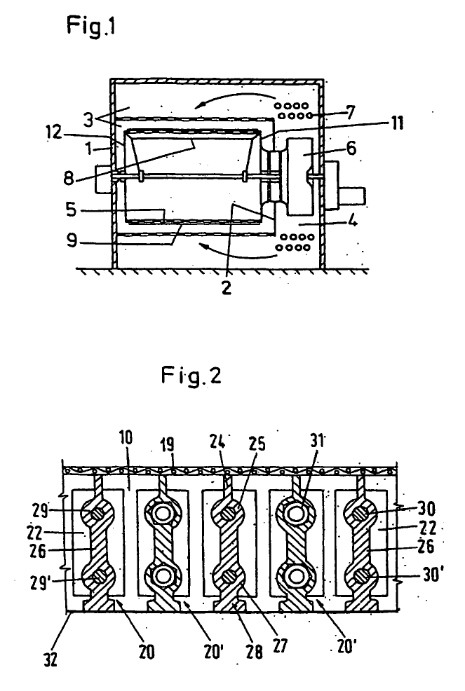

FIG. 2, an enlarged section analogous to FIG. 1 through the sleeve of this known perforated cylinder device;

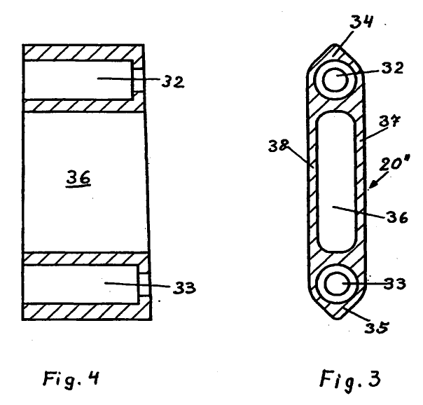

FIG. 3, an analogous enlarged section through a novel connecting element, and

FIG. 4, the connecting element according to FIG. 3 in the form of a section that extends perpendicular to that shown in FIG. 3.

The perforated cylinder device according to FIG. 1 corresponds, e.g., to that disclosed in EP-A-0 315 961. The application hereby refers to the disclosure of this publication.

A perforated cylinder device essentially consists of an approximately rectangular housing 1 that is divided into a treatment chamber 3 and a fan chamber 4 by means of an intermediate wall 2. The perforated cylinder 5 is rotatably supported in the treatment chamber 3, and a fan 6 is rotatably supported concentrically thereto in the fan chamber 4. Naturally, the fan chamber may also be arranged in a not-shown fan housing that is realized separately of the perforated cylinder housing 1. In any case, the fan subjects the interior of the cylinder 5 to suction. This patent also pertains to a cylinder construction for a wet treatment device that may merely serve for removing liquid by suction. The entire construction needs to be adapted accordingly in this case.

According to FIG. 1, heating units 7 are respectively arranged above and underneath the fan 6, wherein said heating units consist of pipes, through which a heating medium flows. In the region that is not covered by the textile material 9, the perforated cylinder is internally protected from the suction draught by means of an interior cover 8. The effective skin of the perforated cylinder is formed by the sheet metal strip structure according to FIG. 2 that is described further below. The outside of this sheet metal strip structure is covered by a fine-meshed screen 19 that is held under tension on the face of the cylinder on the two bottoms 11, 12.

The known sheet metal strip structure consists of axially aligned sheet metal strips 10, the radially extending height of which is elucidated in FIG. 2. Therefore, the screen-like cover 19 only lies on the radially outer edges of the sheet metal strips 10. The sheet metal strips 10 are adjacently fixed on the two bottoms 11, 12 at a defined distance from one another by means of not-shown screws. In order to fix this spacing over the width of the cylinder, connecting elements are provided that serve as spacers and are identified as a whole by the reference symbol 20, wherein said connecting elements are connected to the sheet metal strips 10 by means of screws 29, 29′ and 30, 30′.

According to FIG. 2, the connecting elements 20 feature a rectangular flange 22 at their surfaces that contact the sheet metal strip 10. The radially outer region of the connecting element 20 consists of the web 24. The connecting element 20 also features a radially inner widened leg 28 while the remaining region of the connecting element is realized with a narrow cross section except at the height of the openings 25, 27 for accommodating the screws. The connection between the connecting elements 20 is realized by means of rods 29, 29′ and 30, 30′ that are provided with threads at least on their two ends, wherein nuts 31 are subsequently screwed onto these threaded ends within a connecting element 20′.

The novel connecting element 20″ according to FIGS. 3 and 4 is realized in an altogether streamlined fashion in its radial direction. It features a radially directed arrow point 34, 35 that offers less resistance to the fluid flowing past the connecting element on its two ends that are provided with the bores 32, 33. Between the region at the height of the bores 32, 33, the width of the connecting element 20″ remains unchanged, namely in accordance with the width required for the bores 34, 35. Due to this shape of the connecting element 20″, it no longer contains an edge or groove that could be a cause for soiling.

In order to reduce the weight, the central region of the connecting element 20″ is provided with a hollow chamber 36, the walls 37, 38 of which are only sufficient for the stability and extend parallel to one another with the same thickness.

The cross-sectional width of the walls 37, 38 at the height of the hollow chamber 36 also corresponds approximately to the width of the walls at the height of the bores 32, 33 as illustrated in FIG. 4.

The connecting element according to FIGS. 3, 4 is cast in one piece from metal. The only subsequent processing required are the bores 32, 33. The individual screws 29, 30, the points of which are provided with a hollow thread and the heads of which are provided with normal spike threads [unconfirmed translation] that fit into the hollow threads, need to be connected into a circle around the cylinder by means of a so-called lock in at least one location. The required stove bolt has a larger diameter at least in this one location. The connecting element according to FIG. 3 is no longer usable. In order to attain the aforementioned objective, the connecting element may merely consist of a sheet metal that is bent in the shape of an arrow at least in this location, wherein said sheet metal has the same wall thickness as the walls 37, 38, but is otherwise realized hollow in order to accommodate the lock.

1. A device for the flow-through treatment of textile materials, formed fabrics or paper by means of a gaseous or liquid treatment medium in a perforated cylinder (5) that is covered with a wire gauze (9), wherein straight sheet metal strips (10), the width of which extends in the radial direction, are situated between the bottoms (11, 12) of the cylinder (5), wherein connecting elements (20) arranged between the sheet metal strips (10) are uniformly distributed over the length of the cylinder (5) and rigidly connected to the adjacent sheet metal strips (10) on both sides, and wherein the connecting elements contain more than one bore for screws (29, 29′; 30, 30′) or similar fastening elements in order to connect two adjacent sheet metal strips (10) or connecting elements (20), characterized in that the radially inner and/or outer flanks of the connecting means (20″) are realized in an arrow-shaped fashion and this connecting element is also realized with the same width between the screw holes as at the height of the bores (34, 35).

2. The device according to claim 1, characterized in that the connecting element (20″) is provided with a hollow chamber (36) that extends parallel to the bores (34, 35) at the height between the bores (34, 35).

3. The device according to claim 2, characterized in that the connecting element (20″) is provided with a wall (37, 38) that is only sufficient for the stability of the connecting element (20″) at the height of the hollow chamber.

4. The device according to claim 3, characterized in that the walls (37, 38) provided to both sides of the hollow chamber (36) extend parallel to one another.

5. The device according to claim 1, characterized in that the connecting element merely consists of a sheet metal that is bent in the shape of an arrow and encompasses the two screws (29, 30) or their parts in covering fashion.
